(19) United States
(12) Patent Application Publication
(10) Pub. No.: US 2008/0145009 A1
(43) Pub. Date: Jun. 19, 2008

(54) Buffer tubes with improved flexibility

(75) Inventors: Jeffrey H. Mumm, Marietta, GA (US); Christopher W. McNutt, Woodstock, GA (US); Jeffrey Scott Laws, Brownwood, TX (US)

Correspondence Address: KING & SPALDING LLP, 1180 PEACHTREE STREET, ATLANTA, GA, 30309-3521, US

(73) Assignee: Superior Essex Communications LP.

(21) Appl. No.: 11/640,092

(22) Filed: Dec. 15, 2006

(51) Int. Cl. G02B 6/06

(52) U.S. Cl. 385/113

(57) ABSTRACT

The present invention provides a communication cable buffer tube having a flexural modulus ranging from about 180 kpsi to about 280 kpsi.

### FIELD OF THE INVENTION

This invention generally relates to communication cables. Particularly, the invention relates to communication cables containing optical fibers. More particularly, the invention relates to buffer tubes for fiber optic cables.

### BACKGROUND

Cables containing optical fibers are used to transmit information, including voice, video and data signals, over long distances. They can be grouped into three main categories, which are distinguished by the location of the optical fibers within the cable. For example, in loose tube fiber optic cables, the optical fibers lie in one or more buffer tubes that-are stranded about an elongated central strength member. Each of the buffer tubes usually includes a water-blocking material, such as a gel or other filler material that prevents moisture intrusion. In cases where the buffer tube count is less than the maximum number that can be stranded about the central strength member, the loose tube designs may include one or more flexible filler rods. The filler rods, which are typically fabricated from solid or cellular polymers, are wrapped about the central strength member and help minimize gaps between the central strength member and an outer protective covering or polymer jacket.

Other fiber optic cable designs include monotube and slotted core cables. In monotube cables, the optical fibers are contained within a single, central buffer or core tube that contains a water-blocking agent. In slotted core cables, the optical fibers reside in channels or grooves that have been formed on a surface of a rod-shaped polymer core. The grooves typically follow a helical path along the surface of the core, which reduces compressive and tensile forces on the optical fibers whenever the cable is twisted, stretched, bent or compressed. The helical path traversed by the grooves may reverse direction at regular intervals along the cable's longitudinal axis, which further reduces the forces acting on the optical fibers. In addition to a central strength member and a water-blocking agent, which is disposed in each of the grooves, slotted core cables usually include a buffer tube that covers the slotted core. Both monotube and slotted core cables also include an outer protective covering or polymer jacket.

Each of the fiber optic cable designs—loose tube, monotube, slotted core—may include other components, including reinforcing yarns and fibers, rip cords, strength members and additional water-blocking materials (hot melts, water swellable powders, etc.). The fiber optic cables may also include helically wrapped tapes, corrugated armor and similar layers that help protect the optical fibers within the cable.

The buffer tube or core provides the primary protection for the optical fiber. As a result, the buffer tubes should be robust, exhibit good resistance to compressive, tensile and twisting forces (i.e., crush resistance) while maintaining adequate flexibility over a wide range of temperatures. Other desirable properties include low cost and low moisture sensitivity, as well as good heat resistance, dimensional stability (e.g., low coefficient of thermal expansion) and chemical resistance. A useful parameter for measuring or indicating the robustness, crush resistance and flexibility of a polymer is flexural modulus.

Currently optical fiber buffer tubes are manufactured using polypropylene (PP), polyethylene (PE), copolymers of PP and PE, nucleated copolymers of polypropylene and polyethylene (n-PP), polybutylene terephthalate (PBT), polyamides such as nylon 12, polycarbonate (PC), fluoropolymers, and multiple layers of these materials, such as a dual-wall tube using polybutylene terephthalate and polycarbonate (PBT/PC).

Though useful, none of these materials is completely satisfactory. PBT and PBT/PC are robust, exhibit good crush resistance and are perhaps the most widely used materials for buffer tubes, but they have marginal flexibility, exhibiting a flexural modulus in excess of about 370 kpsi at room temperature. Because of the high flexural modulus and robustness, PBT buffer tubes have a tendency to kink when they are bent instead of uniformly bending with a smooth, gradual radius. Though PBT can be treated to make it more flexible, such treatments increase its cost, making it less attractive for buffer tube applications. Additionally, PBT is susceptible to hydrolysis, which results in a loss of strength following exposure to moisture. Polyamides also are susceptible to hydrolysis and tend to be hygroscopic, which negatively impacts their mechanical and electrical properties and their dimensional stability.

Polyolefins such as PE, PP and copolymers of PE and PP each have a flexural modulus less than about 180 kpsi and therefore exhibit good flexibility. However, these materials generally possess poor crush resistance, making them less useful for buffer tube applications. As compared to PBT, polyolefins such as PE, PP and n-PP exhibit lower tensile, flexural and compressive strength, and lower thermal resistance. Furthermore, PE, PP and many of the copolymers of PE and PP undergo post-extrusion shrinkage, which may result in an increase in excess fiber length (ratio of optical fiber length to buffer tube length) over PBT. Increases in excess fiber length may lead to increased signal attenuation.

### SUMMARY

The present invention provides a communication cable buffer tube having a flexural modulus ranging from about 180 kpsi to about 280 kpsi.

### BRIEF DESCRIPTION OF THE DRAWINGS

The products and processes described herein will be understood in light of FIGS. 1-3, wherein:

FIG. 1 shows a perspective side view of an embodiment of a loose tube fiber optic cable;

FIG. 2 shows a perspective side view of an embodiment of a monotube fiber optic cable; and

FIG. 3 shows a perspective side view of an embodiment of a slotted core tube fiber optic cable.

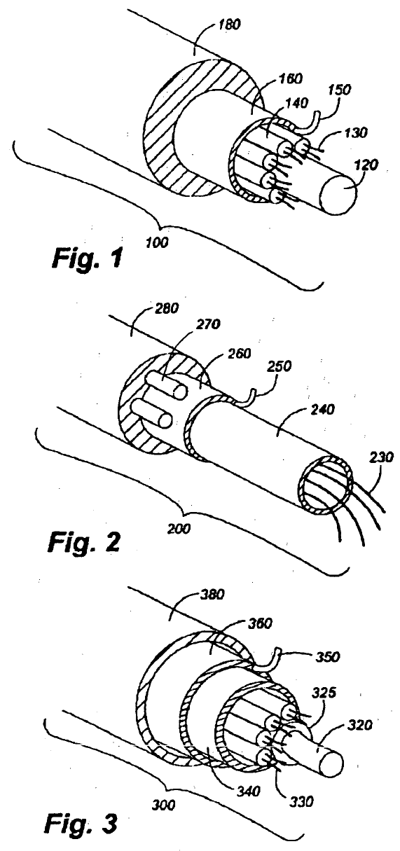

FIGS. 1-3 illustrate specific aspects of the products and processes described in the present specification and constitute a part of the specification. Together with the following description, the Figures demonstrate and explain the principles of the products and processes of the present invention.

### DETAILED DESCRIPTION

The following description includes specific details in order to provide a thorough understanding of the novel cable and buffer tube. The skilled artisan will understand, however, that the products and methods described below can be practiced without employing these specific details. Indeed, they can be modified and can be used in conjunction with products and techniques known to those of skill in the art. For example, this specification describes buffer tubes for use in loose tube optical fiber cables, but the buffer tubes may be used for other types of cables, such as tight buffer or fiber ribbon cables. Indeed, the buffer tubes of the present invention can be used anywhere a robust, crush resistant and flexible tube is needed.

The communication cable generally includes buffer tubes that are robust, crush resistant, flexible, and cost effective. Tubes having these properties allow the cables to be handled in the field without damaging the fibers, and allow easy management of the tubes and cables when routing the tubes and cables. Buffer tubes with these properties can be obtained by using a polymer mixture of an elastic or rubbery additive polymer and a base polymer that is robust and crush resistant. A parameter useful for identifying the robustness, crush resistance and flexibility properties of a polymer or other buffer tube material is flexural modulus. The base polymer typically has a high flexural modulus relative to the flexural modulus of the additive polymer.

Buffer tubes made from PBT exhibit robustness, crush resistance and a flexural modulus of about 380 kpsi, while buffer tubes made from n-PP exhibit flexibility and a flexural modulus of about 180 kpsi. In an embodiment of the invention the polymer mixture has a flexural modulus ranging from about 180 to about 380 kpsi. In another embodiment of the invention the polymer mixture has a flexural modulus ranging from about 180 to about 280 kpsi, thus allowing for enough crush resistance while providing for better flexibility. The polymer mixture may contain a homopolymer, a copolymer, a terpolymer or a mixture thereof. The copolymer may be an alternating copolymer, a random copolymer, a block copolymer, or a graft copolymer.

FIG. 1 illustrates a loose tube fiber optic cable (100) incorporating the buffer tubes of the invention. Typically, this structure incorporates a central strength member (120). A plurality of buffer tubes (140) are placed around the central strength member (120). Optical fibers (130) are contained within the buffer tubes (140). When desired, the buffer tubes (140) can be filled with a gel or other water-blocking agent as known in the art. Radial strength yarns (160) can be wrapped around the central strength member (120) and the buffer tubes (140). A ripcord (150) can be placed within the cable (100) so that the radial strength yarns (160) and outer layers can be at least partially removed to access the inner parts of the cable (100). Optionally, armor such as a metallic shield (not shown) can be placed around the central strength member (120), buffer tubes (140), and the yarns (160) to further protect the cable (100). Lastly, an outer jacket (180) is placed around the internal components of the cable (100).

FIG. 2 illustrates a monotube fiber optic cable (200) incorporating the buffer tubes of the invention. The central core tube (240) contains optical fibers (230). As well, the buffer tube (240) may contain a gel or other water-blocking agent as known in the art. Radial strength yarns (260) are wrapped around the central core tube (240). A ripcord (250) can be placed within the cable (200) so that the radial strength yarns (260). and outer layers can be at least partially removed to access the inner parts of the cable (200). Strength members (270) are placed around the yarns (260) and central core tube (240). The strength members (270) may be placed into different positions within the cable structure. Additionally, armor (not shown) can be placed around the central core tube (240) and the yarn (260) to further protect the cable. Lastly, an outer jacket (280) is placed around the internal components of the cable (200).

FIG. 3 illustrates a slotted tube optical fiber cable (300) containing the buffer tubes of the invention. In cable (300), a slotted core (325) surrounds a central strength member (320). The slotted core (325) contains optical fibers (330) and the slotted core (325), in turn, is contained within a buffer tube (340). The buffer tube (340) may also contain a gel or other water-blocking agent as known in the art. A radial strength yarn (360) is wrapped around the buffer tube (340), slotted core (325), and the central strength member (320). A ripcord (350) can be placed in a position such that the radial strength yarns (360) and other outer layers can be partially or fully removed to access the inner portion of the cable (300). Additionally, armor (not shown) can be placed around the central strength member (320), buffer tube (340), and the yarn (360) to further protect the cable. Lastly, an outer jacket (380) is placed around the internal components of the cable. (300).

The buffer tubes used in the cables are usually made of a polymer mixture. The polymer mixture generally contains a base polymer that is blended with an additive polymer. The base polymer provides robustness and crush resistance, and includes, but is not limited, to, polypropylene (PP), polyethylene (PE), copolymers of PP and PE, nucleated copolymers of polypropylene and polyethylene (n-PP), polybutylene terephthalate (PBT), polyamides, polyethylene terephthalate (PET), polycarbonate (PC), fluoropolymers, polyester elastomers, acetal resins, and a mixture or combination of two or more polymers, such as PBT and polycarbonate (PBT/PC) or PBT and PET (PBT/PET).

A polymer mixture having enough crush resistance while providing for better flexibility can be achieved by reducing the flexural modulus of the base polymer. This can be done by adding or blending a low flexural modulus additive polymer to the high flexural modulus base polymer, such that the polymer mixture exhibits flexibility and robustness between the properties of PP and PBT. In an embodiment the polymer mixture exhibiting the desired robustness, crush resistance and flexibility is achieved by using PBT, PET, PC, or a combination thereof as the base polymer and reducing its flexural modulus by adding or blending a suitable additive polymer into the base polymer.

Additive polymers have a low flexural modulus and are compatible with the base polymer. Additive polymers that have a low flexural modulus and that are suitable for use with PBT, PET, PC and other mixtures or combinations thereof include, but are not limited to, low flexural modulus polyesters, ester-acid terpolymers and ethylene-ester co-polymers. The suitable polyesters include polyurethane, polyvinyl acetate, modified polyesters, co-polyester-ether, and other co-polyesters. Suitable ester-acid terpolymers include ethylene ester acrylic acid terpolymers, such as ethylene methyl acrylate acrylic acid (EMAAA). Suitable ethylene-ester copolymers generally include ethylene and an acrylate co-monomer. The presence of an acrylate co-monomer makes the ethylene-ester compatible with PBT. The ethylene-ester copolymers exhibit excellent compatibility with PBT, chemical and heat resistance, low flexural modulus, and moderate cost. The ethylene-ester copolymers include, but are not limited to, ethylene methyl acrylate (EMA), ethylene butyl acrylate (EBA), and ethylene vinyl acetate (EVA). The flexural modulus of EMA and EBA typically ranges from about 3 to about 6 kpsi. The amount of acrylate co-monomer can be varied from about 20 to about 30 volume percent of the ethylene-ester copolymer in order to achieve the desired compatibility with PBT. In an embodiment the buffer tubes are made from a mixture of PBT and EBA or EMA.

The mixture can be made by any procedure known to those of skill in the art. In an embodiment the additive polymer and base polymer are blended together dry, then melt mixed in an extruder. The amounts of the base polymer and additive polymer in the polymer mixture depend on the desired characteristics of the buffer tubes, as well as cost considerations. In an embodiment of the invention, about 5 to about 50 volume, percent additive polymer is mixed with about 50 to about 95 volume percent base polymer. Mixing the polymers in these amounts produces a buffer tube with adequate cold temperature performance, yet with a flexural modulus in the desired range as detailed above. In addition, mixing the polymers in these amounts minimizes costs: buffer tubes made using these amounts cost about half as much as PBT buffer tubes. In another embodiment, about 5 to about 25 volume percent additive polymer is mixed with about 75 to about 95 volume percent base polymer.

1. A buffer tube for a communication cable, the buffer tube comprising a polymer mixture with a flexural modulus ranging from about 180 to about 380 kpsi.

2. The buffer tube of claim 1, wherein the flexural modulus ranges from about 180 kpsi to about 280 kpsi.

3.-19. (canceled)

20. A communication cable comprising a buffer tube, the buffer tube comprising a polymer mixture with a flexural modulus ranging from about 180 to about 380 kpsi.

21. The cable of claim 20, wherein the flexural modulus ranges from about 180 kpsi to about 280 kpsi.

22.-40. (canceled)

41. The buffer tube of claim 2, further comprising at least one optical fiber disposed therein.

42. The buffer tube of claim 41, further comprising a water-blocking agent disposed between the at least one optical fiber and an inner surface of the buffer tube.

43. The buffer tube of claim 2, wherein the polymer mixture comprises a homopolymer.

44. The buffer tube of claim 2, wherein the polymer mixture comprises a terpolymer.

45. The buffer tube of claim 2, wherein the polymer mixture comprises an alternating copolymer.

46. The buffer tube of claim 2, wherein the polymer mixture comprises a random copolymer.

47. The buffer tube of claim 2, wherein the polymer mixture comprises a block copolymer.

48. The buffer tube of claim 2, wherein the polymer mixture comprises a graft copolymer.

49. The buffer tube of claim 2, wherein the polymer mixture comprises a homopolymer, a copolymer, and a terpolymer.

50. The communication cable of claim 20, wherein the flexural modulus has a value between about 180 kpsi and about 280 kpsi, and wherein the communication cable further comprises an optical fiber disposed in the buffer tube.

51. The communication cable of claim 50, further comprising a powder, operative to swell in response to moisture intrusion, disposed in the buffer tube adjacent a ribbon of optical fibers.

52. The communication cable of claim 50, wherein the buffer tube comprises a homopolymer, a copolymer, and a terpolymer.

53. The communication cable of claim 52, wherein the copolymer comprises a block copolymer.

54. The communication cable of claim 52, wherein the copolymer comprises a graft copolymer.

55. A communications cable comprising:
a jacket extending along the communications cable and defining an internal volume;
a buffer tube, disposed within the internal volume, having a flexural modulus between about 180 kps and about 280 kpsi; and
a plurality of optical fibers disposed within the buffer tube.

56. The communications cable of claim 55, further comprising:
a strength member, centrally disposed within the internal volume, extending lengthwise along the communications cable;
a plurality of other buffer tubes, each containing a respective plurality of other optical fibers, disposed adjacent the longitudinal strength member and extending lengthwise along the communications cable;
a plurality of strength yarns wrapped around the buffer tube, the plurality of other buffer tubes, and the strength member; and
a ripcord disposed adjacent the plurality of strength yarns.
